(19) United States
(12) Patent Application Publication
(10) Pub. No.: US 2023/0069246 A1
(43) Pub. Date: Mar. 2, 2023

(54) CLOVE ESSENTIAL OIL PICKERING EMULSION-BASED COATING PRESERVATIVE, AND PREPARATION METHOD AND USE THEREOF

(71) Applicant: Hefei University of Technology, Hefei (CN)

(72) Inventors: Baocai Xu, Hefei (CN); Zhaoming Wang, Hefei (CN); Lu Hua, Hefei (CN); Jieying Deng, Hefei (CN); Hui Zhou, Hefei (CN)

(21) Appl. No.: 17/725,763

(22) Filed: Apr. 21, 2022

(30) Foreign Application Priority Data
Sep. 2, 2021 (CN) 202111026920 .7

(51) Int. Cl. A23L 3/3472; A23L 3/3526; A23L 3/3544; A23B 4/20

(52) U.S. Cl. CPC A23L 3/3472; A23L 3/3526; A23L 3/3544; A23B 4/20; A23V 2002/00

(57) ABSTRACT

A clove essential oil Pickering emulsion-based coating preservative, and a preparation method and use thereof. Preparing a 20 mg/ml zein solution with ethanol and a zein powder, preparing a 0.4 mg/ml to 6 mg/ml sodium caseinate solution with ultrapure water and sodium caseinate, and conducting magnetic stirring overnight; adding the zein solution dropwise into the sodium caseinate solution, and conducting magnetic stirring; conducting evaporation on the ethanol in the zein solution, and replacing evaporated ethanol with the ultrapure water; adding a clove essential oil, and conducting high-speed homogenization for 3 min to obtain a clove essential oil Pickering emulsion; and preparing a 1.5% w/v to 2% w/v chitosan solution with 1% v/v acetic acid and chitosan, adding the clove essential oil Pickering emulsion to the chitosan solution, conducting high-speed homogenization for 3 min, and conducting ultrasonic defoaming for 30 min to obtain the clove essential oil Pickering emulsion-based coating preservative.

### TECHNICAL FIELD

The present disclosure belongs to the field of food, and in particular relates to a clove essential oil Pickering emulsion-based coating preservative, and a preparation method and use thereof.

### BACKGROUND ART

Essential oils are aromatic and hydrophobic compounds produced by plants with safety, and broad-spectrum antibacterial and antioxidant activities. So far, many essential oils have been used as food preservatives instead of synthetic preservatives in food preservation. Among them, clove essential oil is a natural essential oil with great potential for food preservation. The clove essential oil is extracted from flower buds of clove trunks. Due to high concentrations of eugenol and other phenolic compounds, the clove essential oil has biological and antibacterial activities. The clove essential oil can denature cell proteins and chemically react with cell membrane phospholipids, thereby changing the permeability of cell membrane phospholipids. The clove essential oil kills some important foodborne pathogens, including Staphylococcus aureus, Escherichia coli, Listeria monocytogenes, and Salmonella typhi, and has anti-radical and metal-chelating activities. In addition, the clove essential oil has a strong inhibitory effect on other Gram-positive bacteria, Gram-negative bacteria and fungi. At present, the clove essential oil is generally widely used in the field of food preservation. In some studies, the clove essential oil is directly applied to ham sausage by soaking, and inoculated with Staphylococcus aureus ATCC and Escherichia coli O157: H7; the results show that the clove essential oil can delay the spoilage of ham very well. The clove essential oil, mustard essential oil and cinnamon essential oil are compounded, and it is found that an obtained product has a synergistic effect on the preservation of freshly prepared chicken, which extends a shelf life of the freshly prepared chicken to 21 d.

Applying the clove essential oil directly to food can exert antibacterial and antioxidant effects; however, volatility of the clove essential oil itself will reduce a utilization rate, and a high concentration of the clove essential oil causes food to have a strong special flavor of the clove essential oil. Conversely, a low concentration of the clove essential oil cannot achieve a desired bactericidal effect. In addition, the bacteriostatic and antioxidant activities of clove essential oil decrease more rapidly with time during food refrigeration. Therefore, an encapsulation technology is adopted to inhibit the volatilization and improve the water solubility of clove essential oil, thereby improving the utilization rate and antibacterial properties of the clove essential oil in food preservation. Oil-in-water nanoemulsion has high stability, strong physical and chemical properties, desirable controlled release and desirable biological activity. Until now, common emulsifiers are surfactants, including Tween 20 and Tween 80, such that scholars begin to study natural compounds to prepare solid particles-based stable active substances. Unlike the surfactants, at an oil-water interface, nanoparticles can form a dense interface layer after adsorption, thereby effectively preventing droplets from accumulating. Meanwhile, the nanoparticles have better stability, superior embedding rate, and lower electrolysis rate, providing better protection for active small molecules to a certain extent. Proteins and polysaccharides are generally used as emulsifiers and stabilizers due to thickening and gelling properties. The active small molecules with antibacterial and antioxidant properties are emulsified and made into a coating, and covered on the food surface by wrapping, spraying, and soaking. This treatment blocks the permeation of oxygen, reduces the volatilization of flavor substances and the loss of water, increases the gloss of food surface, prevents the migration and diffusion of components in the food to reduce fat oxidation, and reduces the growth of microorganisms. Therefore, the spoilage of food is delayed to prolong the shelf life.

### SUMMARY

In view of this, an objective of the present disclosure is to provide a clove essential oil Pickering emulsion-based coating preservative, and a preparation method and use thereof. In the present disclosure, a zein/sodium caseinate nanoparticles-embedded clove essential oil is prepared by an anti-solvent method, and effects of different contents of a clove essential oil Pickering emulsion are studied on mechanical properties, water resistance, microstructure, antibacterial properties and release rate of chitosan coatings.

In order to achieve the aforementioned objective, the present disclosure adopts the following technical solution.

The present disclosure provides a preparation method of a clove essential oil Pickering emulsion-based coating preservative, including the following steps:

step S1, preparing a 20 mg/ml zein solution with ethanol and a zein powder, preparing a 0.4 mg/ml to 6 mg/ml sodium caseinate solution with ultrapure water and sodium caseinate, and conducting magnetic stirring for 6 h to 12 h;

step S2, adding the 20 mg/ml zein solution dropwise into the 0.4 mg/ml to 6 mg/ml sodium caseinate solution, and conducting magnetic stirring at 500 rpm for 30 min;

step S3, conducting evaporation on the ethanol in the zein solution at 40° C. using a rotary evaporator, and replacing evaporated ethanol with the ultrapure water to keep a volume of the zein solution unchanged;

step S4, adding a clove essential oil, and conducting high-speed homogenization for 3 min to obtain a clove essential oil Pickering emulsion; and

step S5, preparing a 1.5% w/v to 2% w/v chitosan solution with 1% v/v acetic acid and chitosan, adding 20% w/w glycerol and the clove essential oil Pickering emulsion to the chitosan solution sequentially, conducting high-speed homogenization for 3 min, and conducting ultrasonic defoaming for 30 min to obtain the clove essential oil Pickering emulsion-based coating preservative.

Preferably, 70% to 80% ethanol may be used.

Preferably, in step S2, the zein solution and the sodium caseinate solution may have a ratio of 1:10.

Preferably, in step S4, a 0.5% v/v to 2% v/v clove essential oil may be used.

Preferably, in step S5, the clove essential oil Pickering emulsion may be added to the chitosan solution, such that the clove essential oil has a concentration of 0.2% v/v to 0.6% v/v in a total solution.

Preferably, in steps S4 and S5, the high-speed homogenization may be independently conducted at 15,000 rpm to 20,000 rpm.

The present disclosure further provides a clove essential oil Pickering emulsion-based coating preservative prepared by the preparation method.

The present disclosure further provides use of the clove essential oil Pickering emulsion-based coating preservative as a food preservative. The food preservative is applied to fruits, vegetables and meat products.

The present disclosure further provides a method for preserving roast chicken using the clove essential oil Pickering emulsion-based coating preservative, including the following steps:

step S1, soaking fresh roast chicken in the clove essential oil Pickering emulsion-based coating preservative at 0° C. to 4° C. for 20 sec to 60 sec; and

step S2, transferring the fresh roast chicken to a refrigerating room at 4° C. for draining, and refrigerating in a fresh-keeping bag at 4° C.

Compared with the prior art, the present disclosure has the following beneficial effects:

1. Zein-sodium caseinate nanoparticles emulsify and encapsulate the clove essential oil to reduce the volatilization loss, with an encapsulation rate of the clove essential oil reaching 62.91%.

2. Compared with a pure chitosan coating, the chitosan composite coating with the clove essential oil Pickering emulsion has a tensile strength increased from 26.15 MPa to 38.67 MPa.

3. The clove essential oil Pickering emulsion-based coating preservative shows a strong antibacterial activity to Escherichia coli and Staphylococcus aureus, with an inhibitory zone diameter (IZD) against the Escherichia coli up to 3.29 mm, and an IZD against the Staphylococcus aureus up to 6.15 mm.

4. The clove essential oil Pickering emulsion-based coating preservative can be widely used in the preservation of fruits, vegetables and meat products.

### BRIEF DESCRIPTION OF THE DRAWINGS

FIG. 1 shows a technology roadmap of a preparation method of a clove essential oil Pickering emulsion-based coating preservative;

FIG. 2 shows mechanical strengths of different addition amounts of the clove essential oil Pickering emulsion-based coating preservative;

FIG. 3 shows scanning electron microscope (SEM) images of different addition amounts of the clove essential oil Pickering emulsion-based coating preservative;

FIG. 4 shows Fourier transform infrared spectra of different addition amounts of the clove essential oil Pickering emulsion-based coating preservative;

FIG. 5 shows IZD maps of Escherichia coli and Staphylococcus aureus of different addition amounts of the clove essential oil Pickering emulsion-based coating preservative;

FIG. 6 shows a schematic diagram of a fixed conveyor belt;

FIG. 7 shows finished product display figures of a control group (Example 1) and Example 3; and

FIG. 8 shows the total number of colonies during a storage period of Fuli Roast Chicken.

### DETAILED DESCRIPTION OF THE EMBODIMENTS

In order to describe the technical contents, the structural features, the objectives to be achieved and effects of the technical solution in detail, the following detailed description is further provided with reference to specific examples and accompanying drawings.

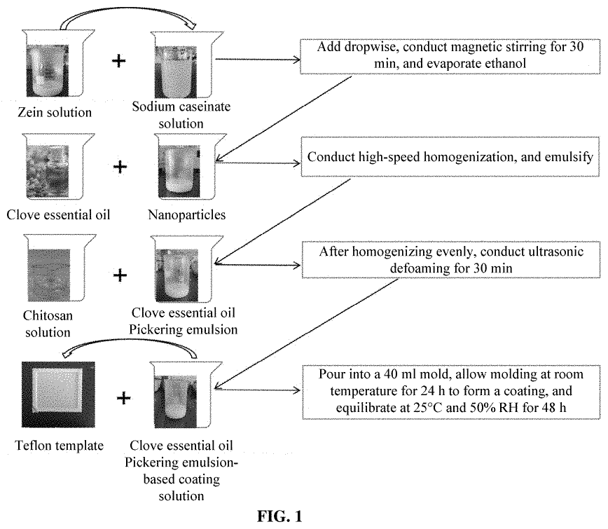

FIG. 1 shows a technology roadmap of a preparation method of a clove essential oil Pickering emulsion-based coating preservative. The present disclosure provides a preparation method of a clove essential oil Pickering emulsion-based coating preservative, including the following steps:

step S1, preparing a 20 mg/ml zein solution with 70% to 80% ethanol and a zein powder, preparing a 0.4 mg/ml to 6 mg/ml sodium caseinate solution with ultrapure water and sodium caseinate, and conducting magnetic stirring for 6 h to 12 h;

step S2, adding 1 ml of the 20 mg/ml zein solution dropwise into 10 ml of the 0.4 mg/ml to 6 mg/ml sodium caseinate solution, and conducting magnetic stirring at 500 rpm for 30 min;

step S3, conducting evaporation on the ethanol in the zein solution at 40° C. using a rotary evaporator, and replacing evaporated ethanol with the ultrapure water to keep a volume of the zein solution unchanged;

step S4, adding a 0.5% v/v to 2% v/v clove essential oil, and conducting high-speed homogenization at 15,000 rpm to 20,000 rpm for 3 min to obtain a clove essential oil Pickering emulsion; and

step S5, preparing a 1.5% w/v to 2% w/v chitosan solution with 1% v/v acetic acid and chitosan, adding the clove essential oil Pickering emulsion to the chitosan solution, such that a concentration of the clove essential oil in a total solution is 0.2% v/v to 0.6% v/v, conducting high-speed homogenization at 15,000 rpm to 20,000 rpm for 3 min, and conducting ultrasonic defoaming for 30 min to obtain the clove essential oil Pickering emulsion-based coating preservative.

The present disclosure further provides a clove essential oil Pickering emulsion-based coating preservative prepared by the preparation method.

The present disclosure further provides use of the clove essential oil Pickering emulsion-based coating preservative as a food preservative. The food preservative is applied to fruits, vegetables and meat products.

### Example 1 (Control Group)

A preparation method of a clove essential oil Pickering emulsion-based coating preservative included the following steps:

step S1, a 1.5% w/v chitosan solution was prepared using 1% v/v acetic acid and chitosan, and 20% w/w glycerol was added to the chitosan solution. Homogenization was conducted at 15,000 rpm for 3 min, and ultrasonic defoaming was conducted for 30 min to obtain a pure chitosan coating preservative (control group).

### Example 2

A preparation method of a clove essential oil Pickering emulsion-based coating preservative included the following steps:

Step S1, a 20 mg/ml zein solution was prepared with 75% ethanol and zein, a 4 mg/ml sodium caseinate solution was prepared with ultrapure water and sodium caseinate, and magnetic stirring was conducted for 12 h.

Step S2, 1 ml of the 20 mg/ml zein solution was added dropwise into 10 ml of the 4 mg/ml sodium caseinate solution, and magnetic stirring was conducted at 500 rpm for 30 min.

Step S3, the ethanol in the zein solution was evaporated at 40° C. using a rotary evaporator, and evaporated ethanol was replaced with the ultrapure water to keep a volume of the zein solution unchanged.

Step S4, a 1% v/v clove essential oil was added, and high-speed homogenization was conducted at 15,000 rpm for 3 min to obtain a clove essential oil Pickering emulsion.

Step S5, a 1.5% w/v chitosan solution was prepared using 1% v/v acetic acid and chitosan, and 20% w/w glycerol was added to the chitosan solution. The clove essential oil Pickering emulsion was added to the chitosan solution, such that the clove essential oil had a concentration of 0.2% v/v in a total solution. Homogenization was conducted at 15,000 rpm for 3 min, and ultrasonic defoaming was conducted for 30 min to obtain a clove essential oil Pickering emulsion-based coating preservative.

### Example 3

A preparation method of a clove essential oil Pickering emulsion-based coating preservative included the following steps:

Step S1, a 20 mg/ml zein solution was prepared with 75% ethanol and zein, a 4 mg/ml sodium caseinate solution was prepared with ultrapure water and sodium caseinate, and magnetic stirring was conducted for 12 h.

Step S2, 1 ml of the 20 mg/ml zein solution was added dropwise into 10 ml of the 4 mg/ml sodium caseinate solution, and magnetic stirring was conducted at 500 rpm for 30 min.

Step S3, the ethanol in the zein solution was evaporated at 40° C. using a rotary evaporator, and evaporated ethanol was replaced with the ultrapure water to keep a volume of the zein solution unchanged.

Step S4, a 1% v/v clove essential oil was added, and high-speed homogenization was conducted at 15,000 rpm for 3 min to obtain a clove essential oil Pickering emulsion.

Step S5, a 1.5% w/v chitosan solution was prepared using 1% v/v acetic acid and chitosan, and 20% w/w glycerol was added to the chitosan solution. The clove essential oil Pickering emulsion was added to the chitosan solution, such that the clove essential oil had a concentration of 0.4% v/v in a total solution. Homogenization was conducted at 15,000 rpm for 3 min, and ultrasonic defoaming was conducted for 30 min to obtain a clove essential oil Pickering emulsion-based coating preservative.

### Example 4

A preparation method of a clove essential oil Pickering emulsion-based coating preservative included the following steps:

Step S1, a 20 mg/ml zein solution was prepared with 75% ethanol and zein, a 4 mg/ml sodium caseinate solution was prepared with ultrapure water and sodium caseinate, and magnetic stirring was conducted for 12 h.

Step S2, 1 ml of the 20 mg/ml zein solution was added dropwise into 10 ml of the 4 mg/ml sodium caseinate solution, and magnetic stirring was conducted at 500 rpm for 30 min.

Step S3, the ethanol in the zein solution was evaporated at 40° C. using a rotary evaporator, and evaporated ethanol was replaced with the ultrapure water to keep a volume of the zein solution unchanged.

Step S4, a 1% v/v clove essential oil was added, and high-speed homogenization was conducted at 15,000 rpm for 3 min to obtain a clove essential oil Pickering emulsion.

Step S5, a 1.5% w/v chitosan solution was prepared using 1% v/v acetic acid and chitosan, and 20% w/w glycerol was added to the chitosan solution. The clove essential oil Pickering emulsion was added to the chitosan solution, such that the clove essential oil had a concentration of 0.6% v/v in a total solution. Homogenization was conducted at 15,000 rpm for 3 min, and ultrasonic defoaming was conducted for 30 min to obtain a clove essential oil Pickering emulsion-based coating preservative.

Instruments and Models:

Instrument 1: T18 IKA high-speed shearing disperser

Instrument 2: UV-6000 ultraviolet and visible spectrophotometer

Instrument 3: TA-XTplus texture analyzer

Instrument 4: JC-100-SE constant temperature humidity chamber

Instrument 5: SU8920 cold-field scanning electron microscope

Instrument 6: Fourier infrared spectroscopy analyzer

Instrument 7: SCIENTZ-09 aseptic homogenizer

The clove essential oil Pickering emulsion prepared in step S4 was centrifuged at 3,500 rpm for 10 min to remove any large particles, and then centrifuged at 10,000 rpm for 30 min. An obtained supernatant was diluted with absolute ethanol, and an absorbance of the clove essential oil was measured by the UV-6000 ultraviolet and visible spectrophotometer at a wavelength of 280 nm. With reference to a standard curve of the clove essential oil (y=0.0129x−0.0157, R²=0.9992), an entrapment rate of Pickering emulsion was calculated for the clove essential oil. The experimental result shows that zein-sodium caseinate nanoparticles emulsify and encapsulate the clove essential oil to reduce the volatilization loss, with an encapsulation rate of the clove essential oil reaching 62.91%.

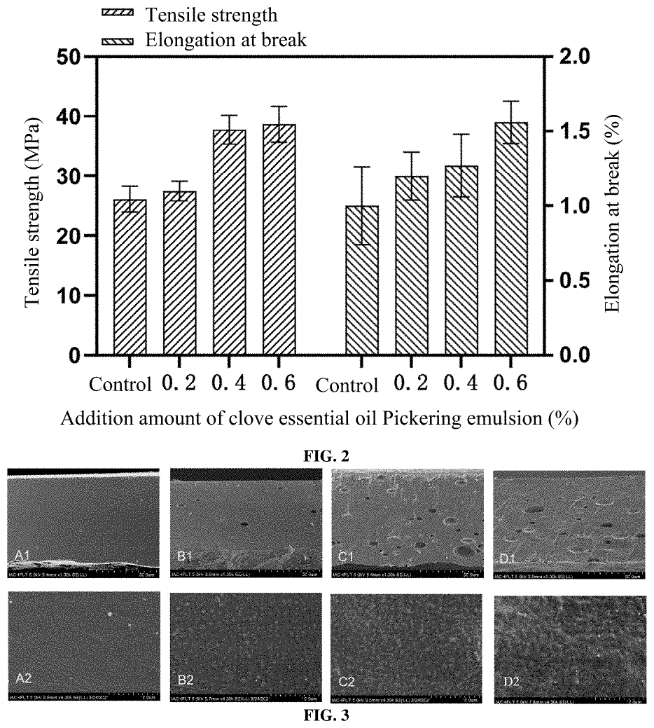

A sample prepared in step S5 was subjected to a tensile test using the texture analyzer of Instrument 3, to test a tensile strength and an elongation at break of the coating. FIG. 2 shows mechanical strengths of different addition amounts of the clove essential oil Pickering emulsion-based coating preservative. Compared with the pure chitosan coating (control group) in Example 1, the chitosan composite coating with the clove essential oil Pickering emulsion (the concentrations of clove essential oil from left to right are: 0.2% in Example 2, 0.4% in Example 3, and 0.6% in Example 4) has a tensile strength increased from 26.15 MPa to 38.67 MPa, and an elongation at break increased from 1% to 1.56%.

The coating was crushed in liquid nitrogen, sticked on a conductive adhesive, gold sputtering was conducted, and a surface and a cross-section of the coating were observed by the scanning electron microscope. FIG. 3 shows scanning electron microscope (SEM) images of different addition amounts of the clove essential oil Pickering emulsion-based coating preservative. A1 to D1 are surfaces of Example 1, Example 2, Example 3, and Example 4 in sequence, and A2 to D2 are cross-sections of Example 1, Example 2, Example 3, and Example 4 in sequence. It is observed by the SEM images that, the clove essential oil Pickering emulsion is embedded in a network structure of the chitosan, with circular protrusions on the surface.

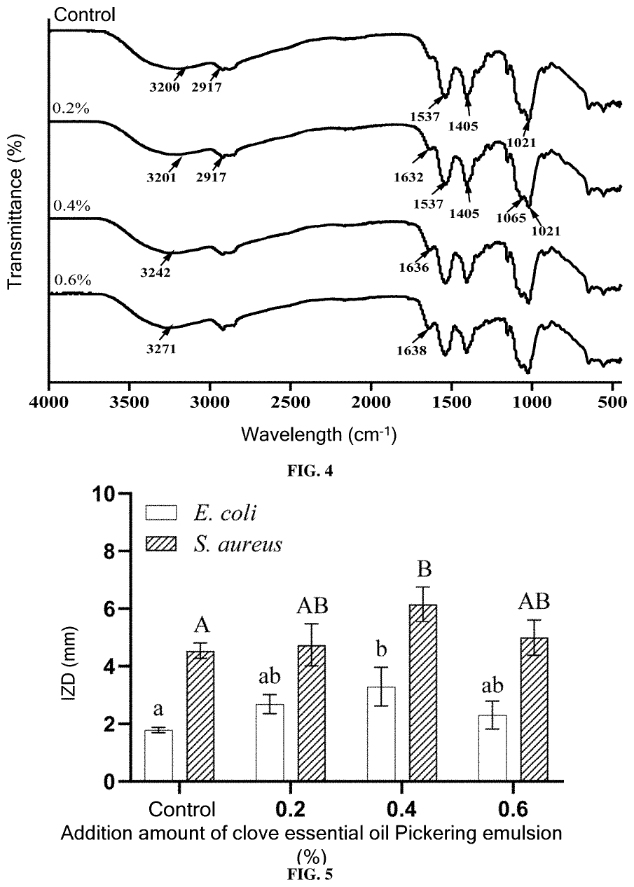

The changes of an internal molecular structure of the clove essential oil Pickering emulsion-based coating were tested by the Fourier infrared spectroscopy analyzer. FIG. 4 shows Fourier transform infrared spectra of different addition amounts of the clove essential oil Pickering emulsion-based coating preservative. The clove essential oil Pickering emulsion makes an absorption peak of the chitosan coating red-shift at 3200 cm⁻¹, indicating that the clove essential oil Pickering emulsion has been closely combined with the chitosan.

According to a slide preparation diffusion method, the Gram-negative bacterium Escherichia coli and the Gram-positive bacterium Staphylococcus aureus were used as tested bacteria, and antibacterial effects of the clove essential oil Pickering emulsion-based coating preservative were tested on these two foodborne pathogens. 100 μL of the cultured 10⁶ cfu/g tested bacteria were injected into an LB plate, and spread evenly. After the plate was slightly dry, a 6 mm sterile blank drug sensitive paper was soaked in a solution of the clove essential oil Pickering emulsion-based coating preservative, and then evenly sticked on the plate coated with the tested bacteria. The plate was placed in a constant-temperature incubator at 37° C. for 24 h to 48 h. IZD was measured with vernier calipers. FIG. 5 shows IZD maps of Escherichia coli and Staphylococcus aureus of different addition amounts of the clove essential oil Pickering emulsion-based coating preservative. The clove essential oil Pickering emulsion-based coating preservative exhibits a strong bacteriostatic activity against the Escherichia coli and Staphylococcus aureus; The IZD of the 0.4% clove essential oil Pickering emulsion-based coating preservative group reaches 3.29 mm to Escherichia coli, and reaches 6.15 mm to Staphylococcus aureus.

A method for preserving fresh roast chicken using the clove essential oil Pickering emulsion-based coating preservative included: Fuli Roast Chicken marinated in Suzhou Huixiangyuan Factory was hung upside down on a fixed conveyor belt shown in FIG. 6. The roast chicken was moved above a preservative soaking tank through the conveyor belt, and a lifting end of a vertical drive mechanism extended out to soak the whole fresh roast chicken in the preservative at 0° C. to 4° C. for 20 sec to 60 sec. The lifting end of the vertical drive mechanism retracted to lift the fresh roast chicken out of the preservative soaking tank; the fresh roast chicken was drained in a 4° C. freezer, put into a fresh-keeping bag and refrigerated at 4° C.

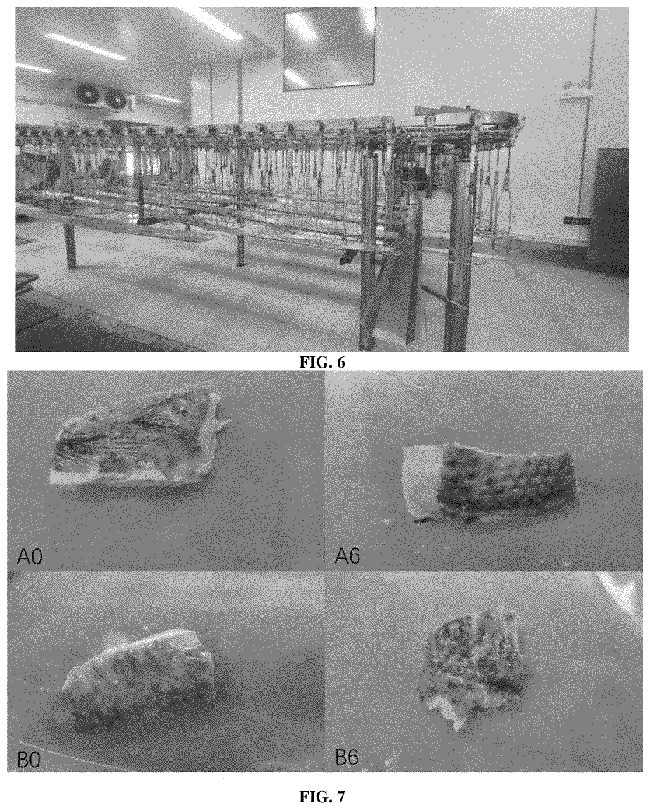

FIG. 7 shows finished product display figures of the control group and Example 3. The finished product display figures are as follows: A0, uncoated roast chicken on a 0th day of storage; A6, uncoated roast chicken on a 6th day of storage; B0, coated roast chicken on the 0th day of storage; B6, coated roast chicken on the 6th day of storage. In the present disclosure, the fresh Fuli Roast Chicken is preserved and stored by the clove essential oil Pickering emulsion-based coating preservative. On a basis of no large-scale contact with the roast chicken, this method is safe, non-toxic, free of secondary pollution, and environmental-friendly, which maintains an original quality of the roast chicken, as well as significantly prolongs a shelf life of the roast chicken.

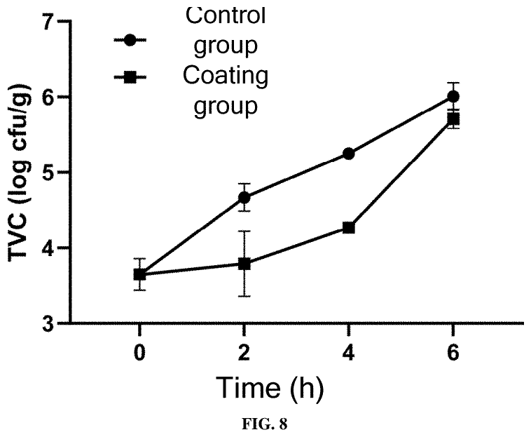

Therefore, the fresh-keeping problem of fresh Fuli Roast Chicken is solved. The total number of microbial colonies in food was determined by GB4789.2-2016. For the finished product prepared in Example 3, sampling was conducted every 2 d for 8 d. In a sterile workbench, 10 g of a meat sample was added into 90 mL of a normal saline, and beat for 2 min by the high-speed shearing disperser of Instrument 1 for homogenization. By 10-fold serial dilution, 100 μL of the sample was spread on a PCA plate evenly. The PCA plate was inverted and incubated in a constant-temperature incubator at 37° C. for 24 h to 48 h. FIG. 8 shows the total number of colonies during the storage period of Fuli Roast Chicken. The fresh Fuli Roast Chicken sold on the market can only be stored until a 2nd day, and has the total number of bacteria reaching 4.7 log cfu/g, which is about to exceed the national standard of 5 log cfu/g; while the fresh Fuli Roast Chicken coated with the clove essential oil emulsion can be stored until a 4th to a 5th day, and has the total number of bacteria on a 6th day reaching 5.71 log cfu/g.

It should be noted that relational terms herein such as first and second are merely used to distinguish one entity or operation from another entity or operation without necessarily requiring or implying any actual such relationship or order between such entities or operations. Moreover, the terms “include”, “comprise” or any other variants thereof are intended to cover non-exclusive inclusion, so that a process, method, article or terminal device including a series of elements not only includes those elements, but also includes those elements that are not explicitly listed, or also includes elements inherent to this process, method, article or terminal device. Without more limitations, the elements defined by the sentence “include . . . ” or “including . . . ” do not exclude the existence of other elements in the process, method, article, or terminal device that includes the elements. In addition, herein, “greater than”, “less than”, “more than”, etc. are understood as not including the number; “above”, “below”, “within”, etc. are understood as including the number.

Although the foregoing examples have been described, those skilled in the art can make additional alterations and modifications to these examples once they learn the basic creative concept. Therefore, the above are only the examples of the present disclosure, but not intended to limit the scope of patent protection of the present disclosure. Any equivalent structure or equivalent process transformation made by using the content of the description and drawings of the present disclosure, or directly or indirectly applied to other related technical fields, are included in the scope of patent protection of the present disclosure.

1. A preparation method of a clove essential oil Pickering emulsion-based coating preservative, comprising the following steps:
step S1, preparing a 20 mg/ml zein solution with ethanol and a zein powder, preparing a 0.4 mg/ml to 6 mg/ml sodium caseinate solution with ultrapure water and sodium caseinate, and conducting magnetic stirring for 6 h to 12 h;
step S2, adding the 20 mg/ml zein solution dropwise into the 0.4 mg/ml to 6 mg/ml sodium caseinate solution, and conducting magnetic stirring at 500 rpm for 30 min;
step S3, conducting evaporation on the ethanol in the zein solution at 40° C. using a rotary evaporator, and replacing evaporated ethanol with the ultrapure water to keep a volume of the zein solution unchanged;
step S4, adding a clove essential oil, and conducting high-speed homogenization for 3 min to obtain a clove essential oil Pickering emulsion; and
step S5, preparing a 1.5% w/v to 2% w/v chitosan solution with 1% v/v acetic acid and chitosan, adding 20% w/w glycerol and the clove essential oil Pickering emulsion to the chitosan solution sequentially, conducting high-speed homogenization for 3 min, and conducting ultrasonic defoaming for 30 min to obtain the clove essential oil Pickering emulsion-based coating preservative.

2. The preparation method of a clove essential oil Pickering emulsion-based coating preservative according to claim 1, wherein 70% to 80% ethanol is used.

3. The preparation method of a clove essential oil Pickering emulsion-based coating preservative according to claim 1, wherein in step S2, the zein solution and the sodium caseinate solution have a ratio of 1:10.

4. The preparation method of a clove essential oil Pickering emulsion-based coating preservative according to claim 1, wherein in step S4, a 0.5% v/v to 2% v/v clove essential oil is used.

5. The preparation method of a clove essential oil Pickering emulsion-based coating preservative according to claim 1, wherein in step S5, the clove essential oil Pickering emulsion is added to the chitosan solution, such that the clove essential oil has a concentration of 0.2% v/v to 0.6% v/v in a total solution.

6. The preparation method of a clove essential oil Pickering emulsion-based coating preservative according to claim 1, wherein in steps S4 and S5, the high-speed homogenization is independently conducted at 15,000 rpm to 20,000 rpm.

7. A clove essential oil Pickering emulsion-based coating preservative prepared by the preparation method according to the steps of
step S1, preparing a 20 mg/ml zein solution with ethanol and a zein powder, preparing a 0.4 mg/ml to 6 mg/ml sodium caseinate solution with ultrapure water and sodium caseinate, and conducting magnetic stirring for 6 h to 12 h;
step S2, adding the 20 mg/ml zein solution dropwise into the 0.4 mg/ml to 6 mg/ml sodium caseinate solution, and conducting magnetic stirring at 500 rpm for 30 min;
step S3, conducting evaporation on the ethanol in the zein solution at 40° C. using a rotary evaporator, and replacing evaporated ethanol with the ultrapure water to keep a volume of the zein solution unchanged;
step S4, adding a clove essential oil, and conducting high-speed homogenization for 3 min to obtain a clove essential oil Pickering emulsion; and
step S5, preparing a 1.5% w/v to 2% w/v chitosan solution with 1% v/v acetic acid and chitosan, adding 20% w/w glycerol and the clove essential oil Pickering emulsion to the chitosan solution sequentially, conducting high-speed homogenization for 3 min, and conducting ultrasonic defoaming for 30 min to obtain the clove essential oil Pickering emulsion-based coating preservative.

8-9. (canceled)

10. The clove essential oil Pickering emulsion-based coating preservative according to claim 7, wherein 70% to 80% ethanol is used.

11. The clove essential oil Pickering emulsion-based coating preservative according to claim 7, wherein in step S2, the zein solution and the sodium caseinate solution have a ratio of 1:10.

12. The clove essential oil Pickering emulsion-based coating preservative according to claim 7, wherein in step S4, a 0.5% v/v to 2% v/v clove essential oil is used.

13. The clove essential oil Pickering emulsion-based coating preservative according to claim 7, wherein in step S5, the clove essential oil Pickering emulsion is added to the chitosan solution, such that the clove essential oil has a concentration of 0.2% v/v to 0.6% v/v in a total solution.

14. The clove essential oil Pickering emulsion-based coating preservative according to claim 7, wherein in steps S4 and 55, the high-speed homogenization is independently conducted at 15,000 rpm to 20,000 rpm.

15. A method for preserving roast chicken using a clove essential oil Pickering emulsion-based coating preservative made by the following step:
step S1, preparing a 20 mg/ml zein solution with ethanol and a zein powder, preparing a 0.4 mg/ml to 6 mg/ml sodium caseinate solution with ultrapure water and sodium caseinate, and conducting magnetic stirring for 6 h to 12 h;
step S2, adding the 20 mg/ml zein solution dropwise into the 0.4 mg/ml to 6 mg/ml sodium caseinate solution, and conducting magnetic stirring at 500 rpm for 30 min;
step S3, conducting evaporation on the ethanol in the zein solution at 40° C. using a rotary evaporator, and replacing evaporated ethanol with the ultrapure water to keep a volume of the zein solution unchanged;
step S4, adding a clove essential oil, and conducting high-speed homogenization for 3 min to obtain a clove essential oil Pickering emulsion; and
step S5, preparing a 1.5% w/v to 2% w/v chitosan solution with 1% v/v acetic acid and chitosan, adding 20% w/w glycerol and the clove essential oil Pickering emulsion to the chitosan solution sequentially, conducting high-speed homogenization for 3 min, and conducting ultrasonic defoaming for 30 min to obtain the clove essential oil Pickering emulsion-based coating preservative;
further comprising the steps of: soaking fresh roast chicken in the clove essential oil Pickering emulsion-based coating preservative at 0° C. to 4° C. for 20 sec to 60 sec; and
transferring the fresh roast chicken to a refrigerating room at 4° C. for draining, and refrigerating in a fresh-keeping bag at 4° C.

16. The method for preserving roast chicken using the clove essential oil Pickering emulsion-based coating preservative according to claim 15, wherein 70% to 80% ethanol is used.

17. The method for preserving roast chicken using the clove essential oil Pickering emulsion-based coating preservative according to claim 15, wherein in step S2, the zein solution and the sodium caseinate solution have a ratio of 1:10.

18. The method for preserving roast chicken using the clove essential oil Pickering emulsion-based coating preservative according to claim 15, wherein in step S4, a 0.5% v/v to 2% v/v clove essential oil is used.

19. The method for preserving roast chicken using the clove essential oil Pickering emulsion-based coating preservative according to claim 15, wherein in step S5, the clove essential oil Pickering emulsion is added to the chitosan solution, such that the clove essential oil has a concentration of 0.2% v/v to 0.6% v/v in a total solution.

20. The method for preserving roast chicken using the clove essential oil Pickering emulsion-based coating preservative according to claim 15, wherein in steps S4 and S5, the high-speed homogenization is independently conducted at 15,000 rpm to 20,000 rpm.
